(19) United States
(12) Patent Application Publication
(10) Pub. No.: US 2005/0209995 A1
(43) Pub. Date: Sep. 22, 2005

(54) Storage of content-location information

(75) Inventors: Emre Baris Aksu, Tampere (FI); Sami Pippuri, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/077,984

(22) Filed: Mar. 10, 2005

Related U.S. Application Data
(60) Provisional application No. 60/552,316, filed on Mar. 10, 2004.

(51) Int. Cl. G06F 7/00

(52) U.S. Cl. 707/1

(57) ABSTRACT

A method, devices, system and software application products for wired or wireless communication. A file format for a DRM (Digital Rights Management) media content is provided. The file format has textual content-location header(s) in a common headers box for indicating content-location information of the media content.

### CROSS REFERENCE TO RELATED APPLICATIONS

This application claims priority under 35 USC §119 to U.S. Provisional Patent Application No. 60/552,316 filed on Mar. 10, 2004.

### FIELD OF THE INVENTION

The invention generally relates to file formats. Especially, certain embodiments of the invention relate to providing a DCF file format (e.g., DCF v2.0 file format) or similar.

### BACKGROUND OF THE INVENTION

OMA DRM Release 2 is standardizing the DCF (DRM Content Format) v2.0 File Format to be used as part of the OMA DRM-enabled services (OMA stands for Open Mobile Alliance; DRM stands for Digital Rights Management). Accordingly, a standard specification: Open Mobile Alliance, DRM Content Format, Draft Version 2.0-16 Jan.-2004 has been drawn up, the contents of this document being incorporated herein by reference. The purpose is to define the content format for DRM protected encrypted media objects and associated meta-data. This content format (or file format) can be used as content-wrapper for many other types of content as well. For example, all components of a SMIL presentation can be “packaged” into a single file with well-defined place-holders and content-definitive meta-data structures. This file format is expected to be commonly used by the industry for multimedia content distribution and storage with or without DRM protection.

3GPP Packet Switched Streaming (PSS, Packet-switched Streaming Service) Release 6 is currently working on adoption of new technologies to enlarge the scope of the 3GPP File Format to enable it to be a “wrapper” file format (i.e., a container file format). It is currently under 3GPP SA4's discussion whether to use the DCF v2.0 file format, or to use the file format extensions, which will be inherited from the new MPEG ISO Base Media File Format Amendment-1 Specification (ISO/IEC 14496-12:2003\115444-12:2003: “ISO base media file format” Amendment-1).

The DCF v2.0 file format can be used as a single container to contain all the components of a multimedia presentation (which can be represented by a SMIL file), or simply archive a collection of multimedia content, be it static or dynamic content. For SMIL presentations, it is desirable to be able to store the directory structure (also called file-tree structure) information of the presentation's media components, in order not to modify the SMIL presentation after “packaging” it into the DCF v2.0 file.

Currently, there is no well-defined or standard way of storing such information in the DCF v2.0 file. Hence, if a user wants to package a SMIL presentation, the user has to modify the SMIL file to contain no paths (or every media component must be at the root directory level as the SMIL file). This has the following impacts:
1. The user may not have DRM rights to modify the SMIL file;
2. There can be file name clashes;
3. There is additional complexity and memory consumption in modifying the SMIL presentation; and/or
4. The directory structure may be lost on the target side, which may like to store the media components in different directories (e.g. images in \images directory, 3GP files in \3GP directory, etc., depending on the Media storage structure defined by the user or the OS-present media gallery application).

ZIP has a directory structure storage capability. ZIP can be considered as a “archive” file format, but with ZIP it is not possible to identify the “maestro” file of the presentation (e.g. a SMIL file which actually defines the whole presentation's layout and structure).

Ericsson has proposed an extension to the ISO Base Media File Format to include the “file-tree” structure and the static media content in the file format, as additional meta-data in MPEG meeting on December 2003. For further information, please see the documents: Ericsson, 3GP file format extensions—container format, 3GPP TSG-SA WG4 Meeting #30, Malaga, Spain, 23-27 Feb. 2004; Ericsson, Per Fröjdh, Presentation and file-tree extensions to the ISO base media file format, ISO/IEC JTC1/SC29WG11, MPEG2003/M10406, December 2003, Waikoloa, USA). The contents of both documents are incorporated herein by reference. Although the presented proposal seems partially to solve the problem, it does not solve the problem relating to DCF v2.0 files, which simply do not make use of this new file format.

### SUMMARY OF THE INVENTION

According to a first aspect of the invention, there is provided a method for communication, the method comprising:
providing a file format for a media content; and
indicating content-location information of the media content with the aid of the file format.

The method is applicable for wireless as well as wired communication.

In accordance with an embodiment of the invention, there is defined a new header in the DCF v2.0 File Format, inside which the content-location information of the media content is stored. With the definition of such a header, each media content inside the file can be extracted to its proper target location or consumed “in place” by establishing a virtual file tree inside a single file. Hence, the same directory structure before “packaging” is preserved. This also means that the presentation lay-out files (e.g. SMIL) do not need to be modified to “flatten” the directory structures or “rename” the duplicate file names.

By using embodiments of the invention, it is possible to have a read-only copyrighted SMIL presentation (e.g. authored by a recognized artist), which is later on used for composing a rich multimedia presentation together with user-generated content (e.g. own pictures, videos).

According to further aspects of the invention, there is provided a sender device, a receiver device, a system, software applications and a file format configured to be used with the method of the first aspect of the invention.

The sender device may be a network element. It may be, e.g., a server in a network, such as the internet or a mobile network. It may be a streaming server or any suitable server used for (multi)media download or file download or file or content delivery. Alternatively, it may be a mobile or fixed terminal device.

The receiver device may be, e.g., a mobile client or a fixed client device.

The software applications may be computer program products, comprising program code, stored on a medium, such as a memory.

Dependent claims relate to embodiments of the invention. The subject matter contained in dependent claims relating to a particular aspect of the invention is also applicable to other aspects of the invention.

### BRIEF DESCRIPTION OF THE DRAWINGS

Embodiments of the invention will now be described by way of example with reference to the accompanying drawings in which:

FIG. 1 shows a schematic high-level overview of the structure of the discrete media profile (DCF)

FIG. 2 shows another illustration of the DCF v2.0 File Format

FIG. 3 shows another embodiment for providing the DCF v2.0 file format with content-location information

FIG. 4 shows a communications system according to an embodiment of the invention.

FIG. 5 is a block diagram of a server according to the present invention

FIG. 6 is a block diagram of a client device according to the present invention

### DETAILED DESCRIPTION

The subject-matter contained in the introductory portion of this patent application may be used to support the detailed description. In the following, the DCF v2.0 is used as an example without an intention to limit the present invention to involve DCF v2.0 only. Any of the methods described in the following can also be used in any possible and functionally suitable combination.

According to the standard specification (Open Mobile Alliance, DRM Content Format, Draft Version 2.0-16 Jan.-2004) mentioned in the section “background of the invention” the OMA DRM defines a delivery method in which a media object is encrypted and the rights containing an encryption key are delivered to a device apart from the media object. The goal of the specification is to define a content format that, in addition to encrypting the media object, supports metadata such as:
original content type of the media object;
unique identifier for this DRM protected media object to associate it with rights;
information about the encryption details;
information about the rights issuing service for this DRM protected media object; and
extensions and other media type dependent metadata.

The standard specification suggests two profiles for the content format. One, that is DCF, is intended to be used with discrete media (such as still images, ring tones, applications, etc.). This profile is used to package and protect discrete media. The discrete media profile allows one to wrap any content in an envelope (DCF). That content is then encrypted as a single object agnostic of the contents internal structure and layout.

The other suggested profile, that is PDCF, is intended to be used with continuous media (e.g., audio, such as music, and video). It is used to protect continuous (packetized) media. The standard specification suggests that continuous media is protected in a separate format because it is packetized. Applications that read and parse continuous media are meant to work on the file on a packet-by-packet basis. To facilitate the playback of protected continuous media, the storage format needs to be structured in such a way that the packets are individually protected. This structurally aware packetization is also required in order to stream continuous media. An OMA DRM compliant streaming server is be able to understand the content format's structure in order to break the content into headers and packets that can be delivered to a client that understands the protected format.

According to the standard specification, both profiles share data structures for the purpose of reusing components. Furthermore, both profiles are based on a widely accepted and deployed standard format, the ISO Base Media File format [IS014496-12], but the discrete media profile is meant to be an all-purpose format, not aiming for full compatibility with ISO media files. According to the standard specification, the content issuer can decide which profile to use for their content, but in general, the profile for continuous media should be used for continuous media content, in order to create a harmonious user experience. The discrete media profile should be used for other types of content. To a user, the difference is that a DCF looks like a DRM protected file, whereas a PDCF looks and functions like a media file to the outside.

Section 5.1 of the above-mentioned standard describes the ISO base media file format and its general relation to the suggested content format.

The ISO base media file format is structured around an object-oriented design of boxes. The suggested DCF v2 file format also has a boxed structure based on the ISO base format. It can be used to “wrap” any media types. It comprises headers section per content object. Content objects may or may not be encrypted. A first content object determines media type visible outside (e.g., SMIL). An other content object may be referenced via a CID mechanism. After mandatory boxes, proprietary extensions are allowed. It also supports embedded file icons, preview etc.

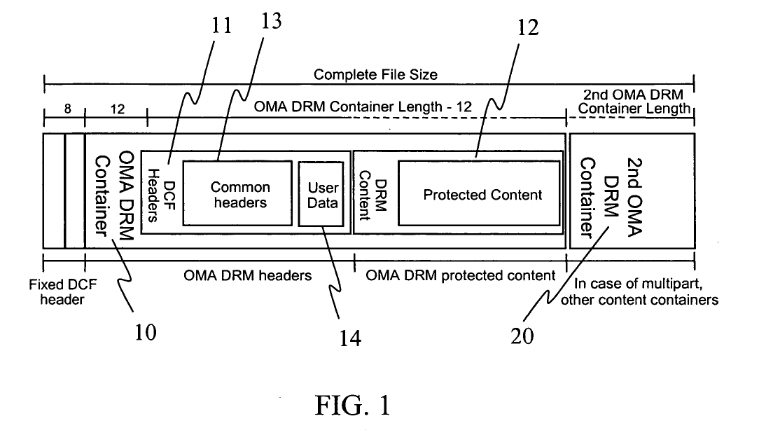

FIG. 1 shows a schematic high-level overview of the structure of the discrete media profile (DCF). The numbers indicating length in FIG. 1 represent octets.

A DCF file includes at least one OMA DRM Container box 10. The OMA DRM Container box 10 is a container for a single content object and its associated headers.

More closely, the format includes the file header (Fixed DCF header), immediately followed by the OMA DRM Container box 10. The OMA DRM Container box 10 includes a DCF headers box 11 and a Protected Content box 12. The design principles for the format include that the DCF headers box 11 is located at a fixed offset from the beginning of the file. The OMA DRM Container box 10 is the first box after the file header; and the DCF headers box 11 is the first box in the OMA DRM Container 10.

The OMA DRM Container box 10 comprises an OMA DRM common headers box 13 and, optionally, a (ISO) user data box 14. In case of multipart, the first OMA DRM Container box 10 is followed by a second OMA DRM Container box 20.

The PDCF profile (or format) differs from the DCF format to some extent. However, a similar common headers box appears also in PDCF.

The standard specification (DCF v2.0) defines a method to extend the meta-data structure of the file format by using the common headers with TextualHeaders field. In other words, the common headers box 14 can comprise textual headers —fields containing additional information of the content. The syntax is as follows:

OtherHeader := Header-name “:” Header-value
Header-name := token
Header-value := token

Using the syntax above, in accordance with an embodiment of the invention, a new custom header is defined as follows:
ContentLocationHeader :=Content-Location “:” Location
Location :=Token
Token=URI (as defined in RFC 2396)|<path>

Some examples are as follows:
Content-Location: “\.” (this means that content is in the same directory as the SMIL presentation);
Content-Location: “\images” (this means that content is in the \images directory one-level below the directory where the SMIL file is present);
Content-Location: “http://server.com/” (this means that content is in the specified HTTP server).

The header name “Content-Location” is just an example name, and may be called differently by different standards (or technical specifications) still covering the same concept.

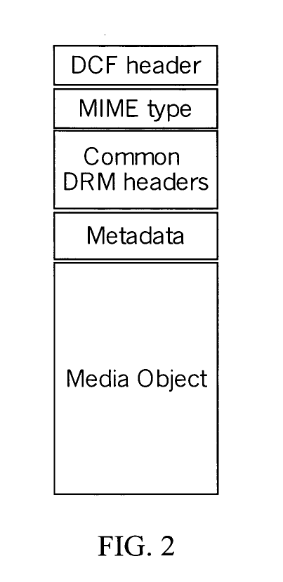

FIG. 2 shows another illustration of the DCF v2.0 File Format. Normally, DCF is designed to be used to protect high-value discrete media objects. It includes the original MIME type of the contained media object. Common DRM headers are used to indicate, e.g., encryption algorithm, where rights may be purchased etc. 3GPP asset information can be used as defined by the 3GP file format. The media object is encrypted and inserted into the wrapper format as such—complete with the original file format.

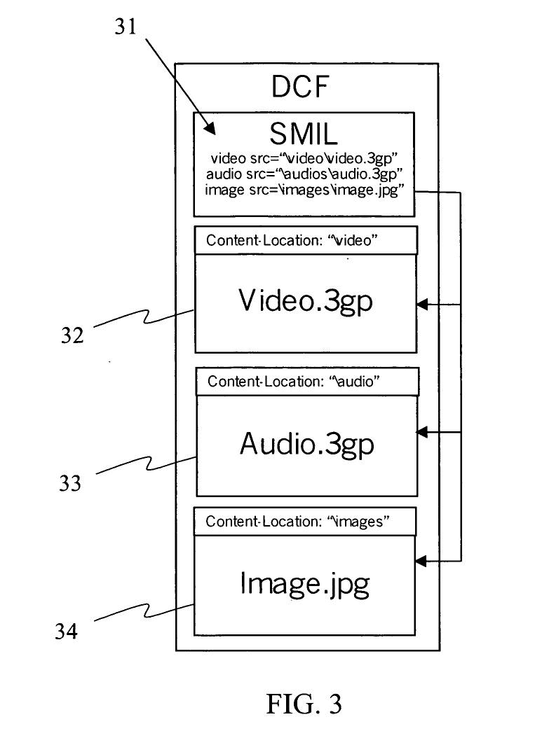

FIG. 3 shows another embodiment for providing the DCF v2.0 file format with content-location information. The DCF format can be used to host multipart multimedia presentations. The first content object determines the media type association, so having a SMIL document 31 as the first object associates the file with a SMIL player. SMIL document may then reference to other objects 32-34 within the file. The SMIL document comprises a set of content-location fields, which indicate a path and a file-name. In addition, each referenced file may contain a content-location field, which provides the path of the content.

According to an embodiment of the invention, file-level interleaving is disabled. Having file-level interleaving would in many cases add unnecessary complexity.

According to an embodiment of the invention, each media data is encapsulated inside a “file”. On the other hand, in the prior-art solution, there exists at least one media track at the main 3GP file level, which makes a physical binding between the container file and some raw media data bitstream. According to an embodiment of the invention, each file has a content-location header. It may reside, e.g., in the beginning of each file.

Some advantages obtained by embodiments of the invention comprise the following:
The content can be mapped easily with the aid of, e.g., the SMIL file and the content-location headers. The directory structure is preserved after a content packaging operation and also restored after a possible extraction of the content.
Content can be played “in place” from the file, e.g., reading the content block-by-block from the file, without extracting it to the file system, thus saving space. This still enables a file tree type of representation of the file's contents.
A progressive download application can make use of this field to understand whether this is the correct content to be fetched.
It is simple to generate and change if, e.g., the SMIL file is modified.
As each file entity contains its own content-location information, it is simple to add or remove content without affecting the other parts of the container file.
Enables mixing high-value, copyrighted and protected works with user-generated, personal content

In some embodiments, the parser/composer must or should be aware of the header, so that if a modification is done, it should be updated.

Extra level of packaging (DCF inside a DCF) can be done in order to mix copyrighted (protected) content with user-generated content.

Published international patent application WO 03/028293 A1 shows a general environment for which embodiments of the invention fit into. The contents of the application are incorporated herein by reference. Especially FIG. 2 of that application shows a transmission system for multimedia content streaming. The system comprises an encoder EC, which may also be referred to as an editor, preparing media content data for transmission typically from a plurality of media sources MS, a streaming server SS transmitting the encoded multimedia files over a network NW and a plurality of clients C receiving the files. The content may be from a recorder recording live presentation, e.g. a video camera, or it may be previously stored on a storage device, such as a video tape, CD, DVD, hard disk etc. The content may be e.g. video, audio, still images, and it may also comprise data files. The multimedia files from the encoder EC are transmitted to the server SS. The server SS is able to serve a plurality of clients C and respond to client requests by transmitting multimedia files from a server database or immediately from the encoder EC using unicast or multicast paths. The network NW may be e.g. a mobile communications network, a local area network, a broadcasting network or multiple different networks separated by gateways.

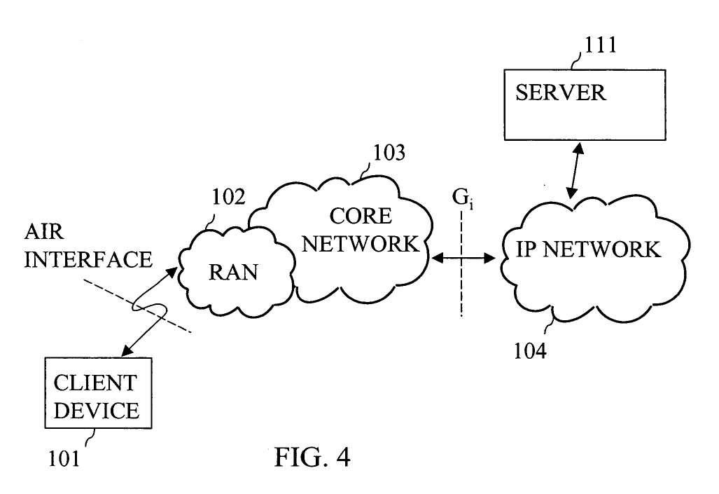

Further, FIG. 4 shows a communications system according to an embodiment of the invention. The system comprises a (streaming) server 111, which is coupled to an IP-network (Internet Protocol) 104. The IP-network 104 may be, for example, the Inter-net or a service provider operator's intranet (an intranet network belonging to the operator's domain). The IP-network 104 is coupled to a core network 103 of a mobile communications network. The coupling may be performed via a Gᵢ interface. The mobile communications network may be, for example, a ‘2.5^{th} generation’ GPRS or EGPRS network, or a 3^{rd} or further generation cellular mobile communications network. The mobile communications network also comprises a radio access network (RAN) 102 coupled to the core network 103. The radio access network 102 provides mobile client devices 101 with access to the mobile communications network over an air-interface. The mentioned access may be provided e.g. by circuit switched means (e.g. circuit switched data call) or packet switched means (e.g. GPRS (General Packet Radio Service)). Accordingly, these techniques may be used to carry media stream packets over the air-interface portion.

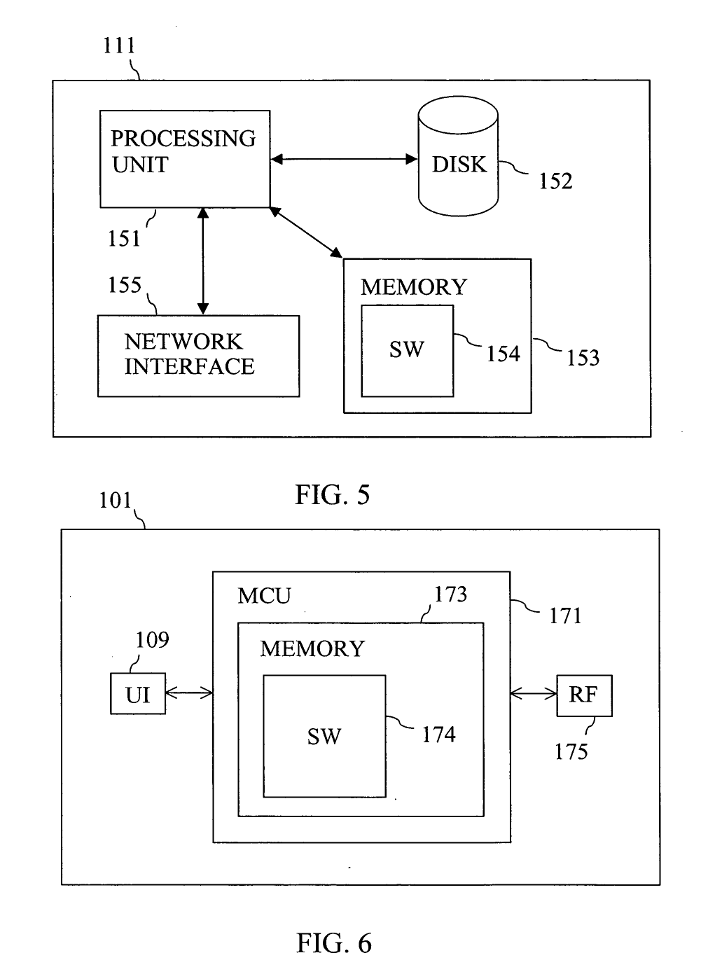

FIG. 5 shows an illustration of the server 111. The server 111 comprises a processing unit 151, a first memory 153, a network interface 155, and a second memory 152. The first memory 153, the network interface 155, and the second memory 152 are coupled to the processing unit 151.

The processing unit 151 controls, in accordance with computer software 154 stored in the first memory 153, the operation of the server 111, such as handling file formats and sending of appropriate contents stored, e.g., in the second memory (disk) 152, to the client 101 via the network interface 155.

The software 154 comprises program code for implementing a suitable layered protocol stack.

FIG. 6 shows an illustration of the client device 101. In this embodiment, the client 101 may be, e.g., a mobile station of a cellular radio telephone network. However, the client may, alternatively, be a fixed terminal.

The client 101 comprises a processing unit 171, a radio frequency part 175, and the user interface 109. The radio frequency part 175 and the user interface 109 are coupled to the processing unit 171. The user interface 109 typically comprises a display, a speaker and a keyboard (not shown) with the aid of which a user can use the client device 101.

The processing unit 171 comprises a processor (not shown), a memory 173 and computer software 174 stored in the memory 173. The processor controls, in accordance with the software, the operation of the client device 101, such as handling of file formats, receiving streaming media or media files from the server 111 and presentation of the received streaming media on the user interface 109.

The software 174 comprises program code for implementing a suitable layered protocol stack.

Procedures relating to file format can be implemented by software. A computer program product comprising program code stored in the receiver device 101 and run in the processor 171 can be used to implement the procedures at the receiving end of a transmission session, whereas a computer program product comprising program code stored in the sender device 111 and run in the processor 151 can be used to implement the procedures at the transmitting end.

Particular implementations and embodiments of the invention have been described. It is clear to a person skilled in the art that the invention is not restricted to details of the embodiments presented above. Furthermore, one skilled in the art will be aware that there are many additional ways to embody this invention, which are within the scope of this invention, even though not shown in one of the limited subset of examples. Especially, the invention should not be limited to any specific names of any protocols or parametres, or field names. The invention can be implemented in other embodiments using equivalent means without deviating from the characteristics of the invention. The scope of the invention is only restricted by the attached patent claims.

1. A method for communication, the method comprising:
providing a file format for a media content; and
indicating content-location information of the media content with the aid of the file format.

2. The method of claim 1, wherein the file format is configured for storing content-location information of the media content inside the file format.

3. The method of claim 1, wherein the media content is comprised in a file having the file format, and wherein the file format indicates a target location to which the media content inside the file should be extracted or whether it should be consumed in place.

4. The method of claim 1, wherein the format comprises a file header, immediately followed by a container box, the container box having a common headers box, the common headers box providing textual header(s) for storing the content-location information.

5. The method of claim 1, wherein the method comprises establishing a virtual file tree inside a single file having one or more media contents.

6. The method of claim 1, wherein the file format contains metadata, such as a header field, indicating said content-location information.

7. The method of claim 1, wherein the file format is communicated between a sender and a receiver.

8. The method of claim 1, wherein the file format is “file-based” so that it is comprised in each file.

9. The method of claim 1, wherein the file format is for delivery method in which a media object is encrypted and the rights containing an encryption key are delivered to a device apart from the media object.

10. The method of claim 1, wherein the file format has a boxed structure based on an ISO Base Media File format, the file format being a DCF v2.0 file format or similar.

11. The method of claim 1, wherein the file format comprises a content-location header indicating a path of the media content.

12. The method of claim 11, wherein the path is indicated as an URI (Uniform Resource Indicator).

13. The method of claim 1, wherein the file format indicates a filename of the media content.

14. A sender device for communication comprising:
means for generating a file format for a media content; and
means for sending the file format to a receiver, wherein the file format indicates content-location information of the media content.

15. The sender device of claim 14, wherein the file format is configured for storing content-location information of the media content inside the file format.

16. The sender device of claim 14, wherein the format comprises a file header, immediately followed by a container box, the container box having a common headers box, the common headers box providing textual header(s) for storing the content-location information.

17. The sender device of claim 14, wherein the file format is configured for establishing a virtual file tree inside a single file having one or more media contents.

18. The sender device of claim 14, wherein the file format comprises a content-location header indicating a path of the media content.

19. The sender device of claim 14, wherein the file format indicates a filename of the media content.

20. The sender device of claim 14, wherein the sender device is a network element, such as a server or web server.

21. A receiver device for communication comprising:
means for receiving a file format for a media content; and
means for using the file format, wherein the file format indicates content-location information of the media content.

22. The receiver device of claim 21, wherein the file format is configured for storing content-location information of the media content inside the file format.

23. The receiver device of claim 21, wherein the format comprises a file header, immediately followed by a container box, the container box having a common headers box, the common headers box providing textual header(s) for storing the content-location information.

24. The receiver device of claim 21, wherein the file format is configured for establishing a virtual file tree inside a single file having one or more media contents.

25. The receiver device of claim 21, wherein the file format comprises a content-location header indicating a path of the media content.

26. The receiver device of claim 21, wherein the file format indicates a filename of the media content.

27. The receiver device of claim 21, wherein the receiver device is a fixed or mobile terminal.

28. A system comprising the sender device of claim 14, a network and a receiver device of claim 21, the system being configured to employ the method of claim 1.

29. The system of claim 28, wherein the file format is communicated between the sender and the receiver via the network.

30. The system according to claim 28, wherein the network is wireless, at least in part.

31. A software application product executable in a sender device, the software application stored on a readable medium, such that when executed, the software application product:
generates a file format for a media content; and
causes the sender device to send the file format to a receiver, wherein the file format indicates content-location information of the media content.

32. A software application product executable in a receiver device, the software application stored on a readable medium, such that when executed, the software application product:
receives a file format for a media content; and
interprets the file format, wherein the file format indicates content-location information of the media content.

33. A file format for a media content, wherein the file format is configured for storing content-location information of the media content inside the file format.
